(19) United States
(12) Patent Application Publication
(10) Pub. No.: US 2026/0017546 A1
(43) Pub. Date: Jan. 15, 2026

(54) Configurable Qubit Electronics with Controlled Output Frequencies

(71) Applicant: International Business Machines Corporation, Armonk, NY (US)

(72) Inventors: Timothy LINDQUIST, Rochester, MN (US); Jarrett BETKE, Hoffman Estates, IL (US); George Russell ZETTLES, IV, Rochester, MN (US); Scott M. WILLENBORG, Stewartville, MN (US); Brian David ALLISON, Rochester, MN (US); Jeremy T EKMAN, West Concord, MN (US); Matthew A. WALTHER, Rochester, MN (US)

(21) Appl. No.: 18/526,101

(22) Filed: Dec. 1, 2023

(51) Int. Cl. G06N 10/20; G06N 10/40

(52) U.S. Cl. CPC G06N 10/20; G06N 10/40

(57) ABSTRACT

A system comprises a memory that stores and a processor that executes computer executable components stored in the memory, wherein the computer executable components comprise a selection component that identifies a set of frequencies for an operating frequency (OF) of a free running oscillator of qubit control electronics corresponding to a qubit of a quantum system, and a waveform direction component that maintains a constant phase relationship between varying resonating frequency (RF) pulses output by the qubit control electronics.

### BACKGROUND

In quantum computing systems, quantum processors can comprise a plurality of qubits, such as in the hundreds or in the future, in the thousands, millions or even billions. Qubits can have a respective resonant frequencies. Qubits can be associated with qubit control electronics, such as individual qubit control electronics, that can operate relative to the respective resonant frequencies of the qubits.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments, systems, computer-implemented methods, apparatuses and/or computer program products described herein can provide for control of a quantum payload having increasingly large numbers of qubits by way of a system of digital to analog converters comprising built-in oscillators, such as numerically controlled oscillators, such as being free running.

In accordance with an embodiment, a system can comprise a memory that stores and a processor that executes computer executable components stored in the memory, wherein the computer executable components comprise a selection component that identifies a set of frequencies for an operating frequency (OF) of a free running oscillator of qubit control electronics corresponding to a qubit of a quantum system, and a waveform direction component that maintains a constant phase relationship between varying resonating frequency (RF) pulses output by the qubit control electronics.

In accordance with another embodiment, a computer-implemented method can comprise identifying, by a system operatively coupled to a processor, a set of frequencies for an operating frequency (OF) of a free running oscillator of qubit control electronics corresponding to a qubit of a quantum system, and maintaining, by the system, a constant phase relationship between varying resonating frequency (RF) pulses output by the qubit control electronics.

In accordance with still another embodiment, a computer program product facilitating a process to support control of output of resonating frequencies of qubit control electronics of a quantum system, the computer program product comprising a computer readable storage medium having program instructions embodied therewith, the program instructions executable by a processor to cause the processor to identify, by the processor, a set of frequencies for an operating frequency (OF) of a free running oscillator of the qubit control electronics corresponding to a qubit of the quantum system, and maintain, by the processor, a constant phase relationship between varying resonating frequency (RF) pulses output by the qubit control electronics.

A benefit of the system, computer-implemented method and/or computer program product can be an ability to control an increasingly large quantum payload using free running NCOs while still be able to maintain consistent phase between varying RF pulses generated by the qubit control electronics of a quantum system, comprising the quantum payload, and between varying RF pulses generated relative to an analog to digital converter (ADC), at the acquire path of the qubit control electronics, that directly acquires the RF pulses. Indeed, quantum experiments can comprise a statistical process employing repeated trials. Maintaining stable phase amongst trials can allow for repeatable results.

Another benefit of the system, computer-implemented method and/or computer program product can be an ability to, during quantum system setup, configure qubit control electronics that can, during use of the quantum system, directly generate and transmit resonating frequencies (RFs) to qubits and/or to readout resonators associated with the qubits to thereby drive the qubits and/or obtain readout measurements regarding the qubits' states, rotations, etc. function with qubits having varying resonant frequencies, including atypical frequencies.

Still another benefit of the system, computer-implemented method and/or computer program product can be an ability to omit separate local oscillator components (e.g., those that are not built into digital to analog converters (DACs) thereby providing for reduced use of real estate in control electronics space of a quantum system. Accordingly, increased density, reduced cabling, and reduced card footprint used by individual qubit control electronics can be enabled, as compared to existing frameworks. The reduction in and/or omission of separate oscillator components further is a cost-saving mechanism.

### DESCRIPTION OF THE DRAWINGS

FIG. 1 illustrates a block diagram of an example, non-limiting system that can provide a process to manage qubit control electronics of a quantum system, in accordance with one or more embodiments described herein.

FIG. 2 illustrates a block diagram of another example, non-limiting system that can provide a process to manage qubit control electronics of a quantum system, in accordance with one or more embodiments described herein.

FIG. 3 illustrates a block diagram of a quantum system that can be employed in connection with the non-limiting systems of FIGS. 1 and 2, in accordance with one or more embodiments described herein.

FIG. 4 provides a schematic illustration of a portion of the quantum system of FIG. 3, in accordance with one or more embodiments described herein.

FIG. 5 provides another schematic illustration of a portion of the quantum system of FIG. 3, in accordance with one or more embodiments described herein.

FIG. 6 provides a pair of graphs illustrating unstable phase versus stable phase, thereby demonstrating a process that can be performed by the non-limiting system of FIG. 2, in accordance with one or more embodiments described herein.

FIG. 7 illustrates a graph demonstrating the Nyquist limit in relation to the non-limiting system of FIG. 2, in accordance with one or more embodiments described herein.

FIG. 8 illustrates a flow diagram of one or more processes that can be performed by the non-limiting system of FIG. 2, to control qubit control electronics employing a digital to analog converter having a built-in oscillator, in accordance with one or more embodiments described herein.

FIG. 9 illustrates a continuation of the flow diagram of FIG. 8 of one or more processes that can be performed by the non-limiting system of FIG. 2, in accordance with one or more embodiments described herein.

FIG. 10 illustrates a block diagram of an example, non-limiting, computer environment in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In practice, quantum processors can comprise a plurality of qubits, such as in the hundreds, or in the future, in the thousands, millions and/or even billions. Each qubit can be associated with one or more qubit control electronics, such as a qubit control card, qubit acquire card and/or qubit drive card. However, increased qubit numbers require increased amounts of qubit control electronics, which are costly, take up space, require individual cabling, etc. Each qubit control electronics can comprise at least a pair of digital to analog converters (DACs) and a corresponding pair of local oscillators (LOs).

To account for one or more of these deficiencies, according to one or more embodiments described herein, different from existing frameworks, to reduce space used, reduce footprint of cards used, and/or reduce cabling, local oscillators of qubit control electronics are omitted and instead the DACs can have oscillators built in. To allow for direct digital synthesis, numerically controlled oscillators (NCOs) such as free running NCOs (FRNCOs) can be built into the DACs.

An added benefit of such setup, as compared to existing frameworks unable to provide such benefit, is that RF tones can be directly generated and output by the DACs without first outputting intermediate frequencies (IFs) external to the DACs.

As used herein, above and below, the term “free running” refers to continuous running with respect to a quantum experiment instruction set, as opposed to running only when directed relative to the quantum experiment instruction set.

In connection therewith, initial setup of such qubit control electronics, also herein referred to as quantum control electronics, can be fraught with difficulty due to the free running nature of the operating frequency (OF) of the NCO.

To account for this problem, one or more embodiments provided herein provide a solution. The solution can comprise determination of how to match timing of generation of IF pulses by the DAC with a free running operating frequency (OF) of a respective NCO, while maintaining consistent phase between varying RF pulses output by the DAC, and between the DAC and an analog to digital converter (ADC) that directly acquires the RF pulse. That is, desirably, each identical IF pulse generated and combined with the free running OF of the NCO should allow for generation, by the DAC, of a same (e.g., identical) RF pulse. The RF pulses also should provide for adequate sampling and thus the RF pulses should not approach an undesirable Nyquist rate, which can undesirably cause low fidelity signals due to the signals being constructed with few points in a period, referred to as Nyquist roll off.

As such, the one or more embodiments herein can provide for automatic or at least partially automatic setup of qubit control electronics (e.g., setup of an NCO and associated DAC) for controlling a qubit/operating with a readout resonator, and further being based on a resonant frequency of the qubit.

As used herein, the term “information” can comprise data and/or metadata in any suitable form, code and/or language.

As used herein, the term “data” can comprise metadata.

As used herein, the terms “entity,” “requesting entity,” and “user entity” can refer to a machine, device, component, hardware, software, smart device, party, organization, individual and/or human.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident in various cases, however, that the one or more embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

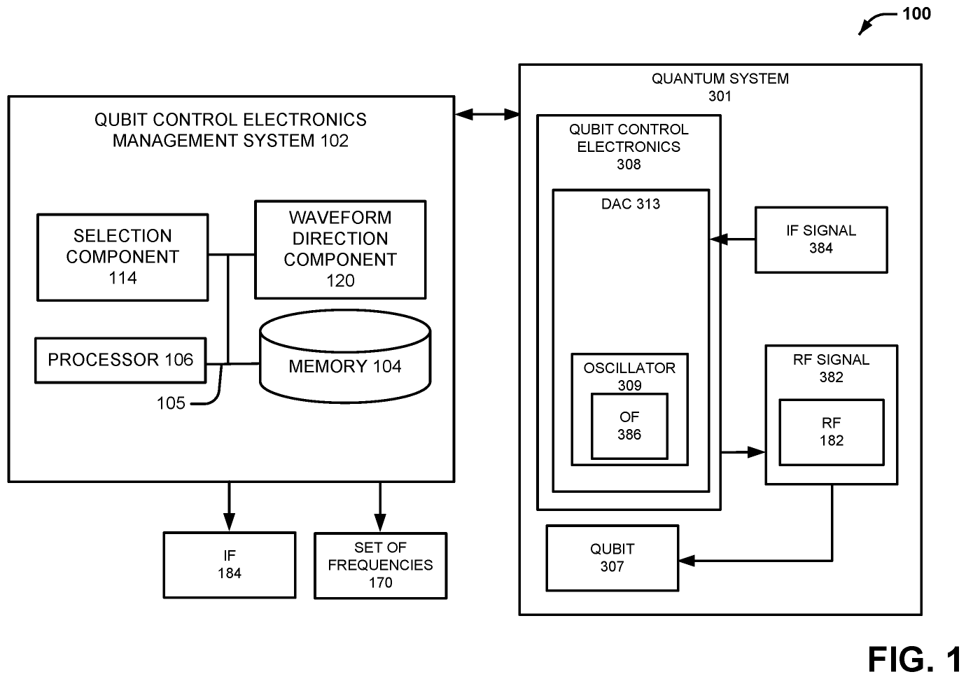

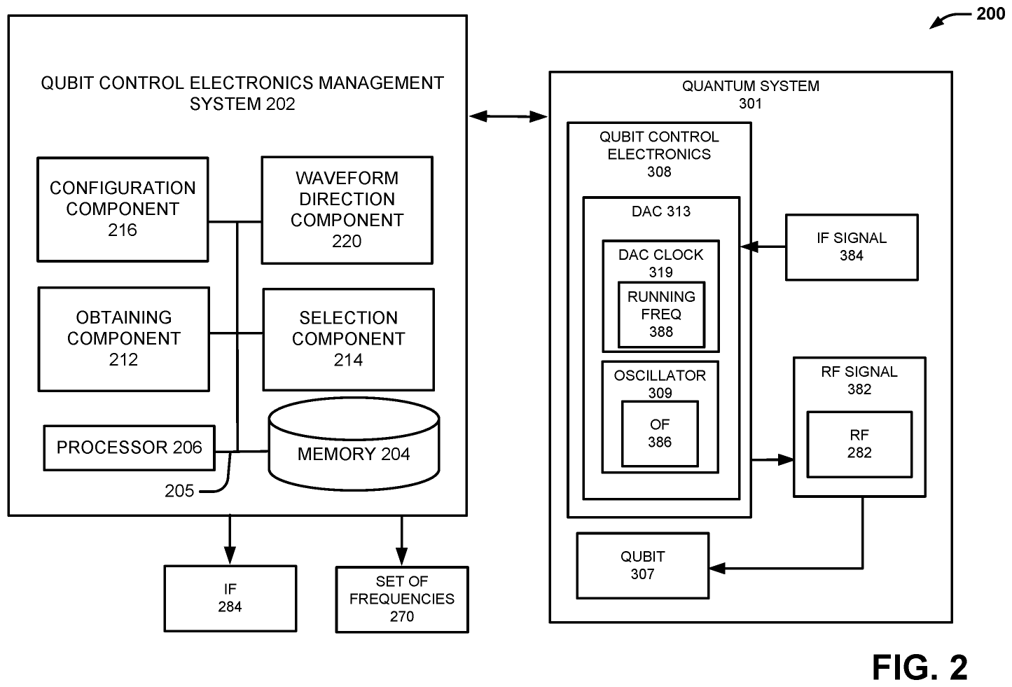

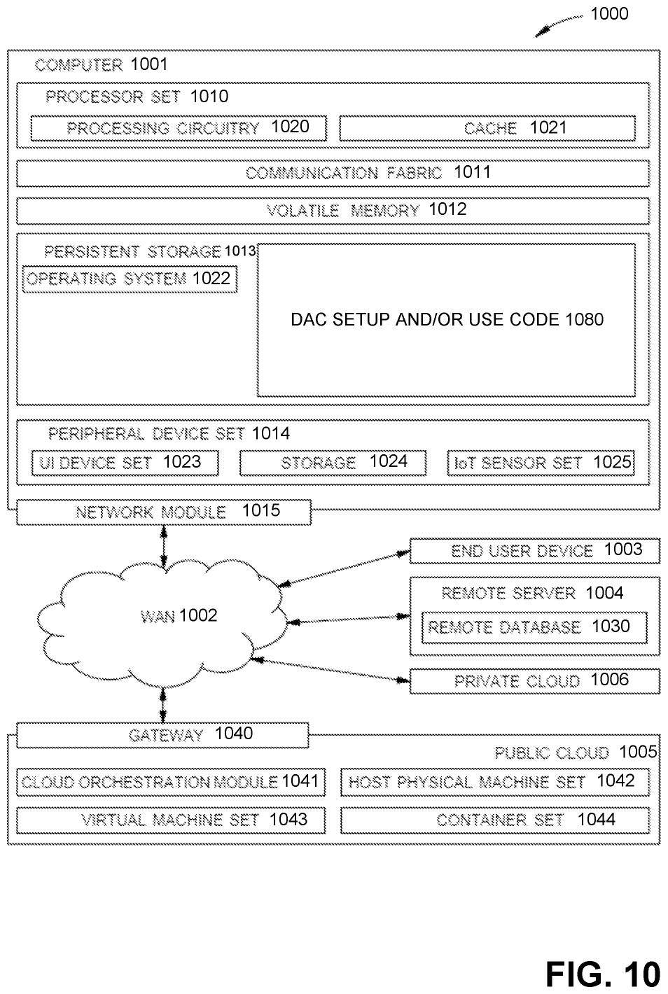

For example, in one or more embodiments, the non-limiting systems 100 and/or 200 illustrated at FIGS. 1 and 2, and/or systems thereof, can further comprise one or more computer and/or computing-based elements described herein with reference to a computing environment, such as the computing environment 1000 illustrated at FIG. 10. In one or more described embodiments, computer and/or computing-based elements can be used in connection with implementing one or more of the systems, devices, components and/or computer-implemented operations shown and/or described in connection with FIGS. 1 and/or 2 and/or with one or more other figures described herein.

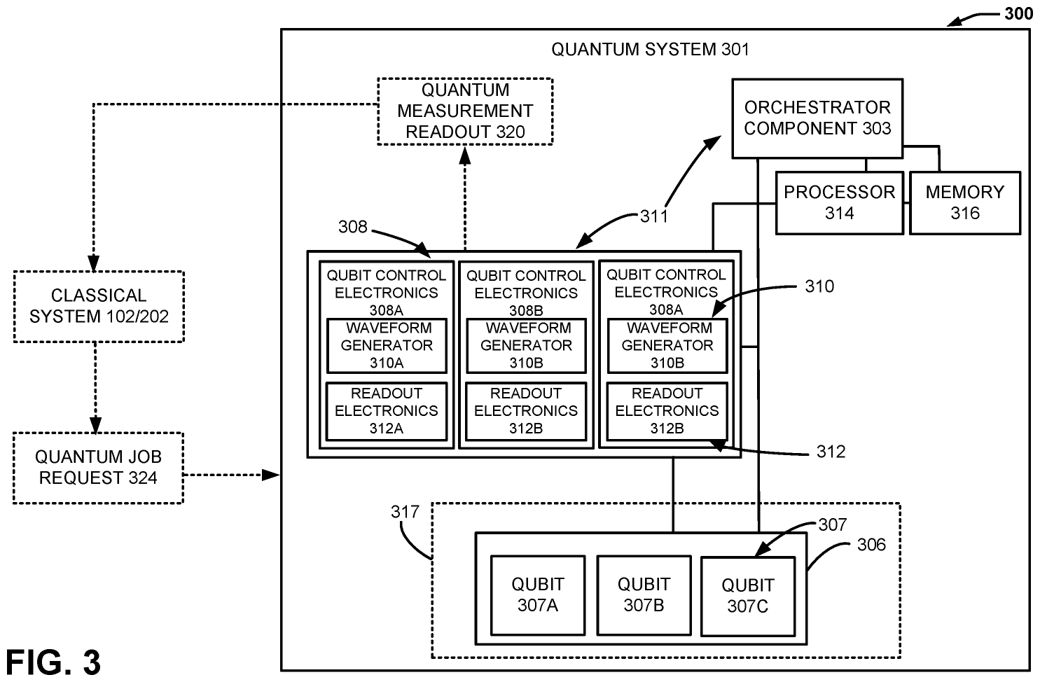

Turning now in particular to one or more figures, and first to FIG. 1, the figure illustrates a block diagram of an example, non-limiting system 100 that can facilitate a process to support control of output of resonating frequencies of qubit control electronics, such as qubit control electronics 308, of a quantum system 301 (FIG. 3).

The non-limiting system 100 can comprise a qubit control electronics management system 102 and a quantum system 301, to be described in detail below. It is noted that the qubit control electronics management system 102 is only briefly described relative to FIG. 1 to provide but a lead-in to description of a more complex and/or more expansive qubit control electronics management system 202 as illustrated at FIG. 2. That is, further detail regarding processes that can be performed by one or more embodiments described herein will be provided below relative to the non-limiting system 200 of FIG. 2.

Still referring to FIG. 1, the qubit control electronics management system 102 can comprise at least a memory 104, bus 105, processor 106, selection component 114 and/or waveform direction component 120. Using these components and a digital to analog converter (DAC) 313 of the quantum system 301, the qubit control electronics management system 102 can provide setup of system resources, such as qubit control electronics 308 comprising the DAC 313, at the quantum system 301, allowing for control of qubits 307 and/or readout resonators associated with the qubits 307 of the quantum system 301.

Generally, the selection component 114 can identify a set of frequencies 170 for an operating frequency (OF) 386 (e.g., a known OF 386) of a free running oscillator 309 of qubit control electronics 308 corresponding to a qubit 307 of a quantum system 301.

As noted above, the term “free running” refers to continuous running with respect to a quantum experiment instruction set, as opposed to running only when directed relative to the quantum experiment instruction set.

In one or more embodiments, the free running oscillator 309 can be a numerically controlled oscillator 309. Additionally and/or alternatively, the free running oscillator 309 can be built into a digital to analog converter 313 of the qubit control electronics 308.

The waveform direction component 120 generally can maintain a constant phase relationship between varying resonating frequency (RF) pulses 382 output by the qubit control electronics 308, such as by the DAC 313.

As used herein, “phase” can refer to a relationship between two or more signals that share a same frequency. More particularly, phase can involve a relationship between positions of oscillatory aspects, such as amplitude crests and troughs of between waveforms defining the signals.

The DAC 313 generally can combine an intermediate frequency (IF) 184 with the OF 386 to generate an RF signal (or pulse) 382 having an RF 182.

It is noted that the selection component 114 and/or the waveform direction component 120 can operate at a classical system of and/or comprising the qubit control electronics management system 102.

In general, the non-limiting system 100 can employ any suitable method of communication (e.g., electronic, communicative, internet, infrared, fiber, etc.) to provide communication between the qubit control electronics management system 102 and the quantum system 301.

Turning next to FIG. 2, a non-limiting system 200 is illustrated that can comprise a qubit control electronics management system 202. Repetitive description of like elements and/or processes employed in respective embodiments is omitted for sake of brevity. Description relative to an embodiment of FIG. 1 can be applicable to an embodiment of FIG. 2. Likewise, description relative to an embodiment of FIG. 2 can be applicable to an embodiment of FIG. 1.

Generally, the non-limiting system 200 that can facilitate a process to support control of output of resonating frequencies of qubit control electronics, such as qubit control electronics 308, of a quantum system 301 (FIG. 3).

Turning first to the qubit control electronics management system 202, one or more communications between one or more components of the non-limiting system 200 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The qubit control electronics management system 202 can be associated with, such as accessible via, a cloud computing environment.

The qubit control electronics management system 202 can comprise a plurality of components. The components can comprise a memory 204, processor 206, bus 205, obtaining component 212, selection component 214, configuration component 216 and/or waveform direction component 220. Using these components, and using operation of a DAC 313 of qubit control electronics 308 of the quantum system 301, the qubit control electronics management system 202 can generally determine an operating frequency (OF) 386 at which to operate an oscillator 309 of the qubit control electronics 308, and further can compile an intermediate frequency (IF) 284 for use with the OF 386 to generate a resonating frequency (RF) 282, which is a radio frequency pulse that is made by combining the IF with the OF, that can provide for sufficient control relative to a qubit 307 (e.g., for driving the qubit 307 and/or for accessing a readout resonator associated with the qubit 307).

Discussion first turns briefly to the processor 206, memory 204 and bus 205 of the qubit control electronics management system 202. For example, in one or more embodiments, the qubit control electronics management system 202 can comprise the processor 206 (e.g., computer processing unit, microprocessor, classical processor, quantum processor and/or like processor). In one or more embodiments, a component associated with qubit control electronics management system 202, as described herein with or without reference to the one or more figures of the one or more embodiments, can comprise one or more computer and/or machine readable, writable and/or executable components and/or instructions that can be executed by processor 206 to provide performance of one or more processes defined by such component and/or instruction. In one or more embodiments, the processor 206 can comprise the obtaining component 212, selection component 214, configuration component 216 and/or waveform direction component 220.

In one or more embodiments, the qubit control electronics management system 202 can comprise the computer-readable memory 204 that can be operably connected to the processor 206. The memory 204 can store computer-executable instructions that, upon execution by the processor 206, can cause the processor 206 and/or one or more other components of the qubit control electronics management system 202 (e.g., obtaining component 212, selection component 214, configuration component 216 and/or waveform direction component 220) to perform one or more actions. In one or more embodiments, the memory 204 can store computer-executable components (e.g., obtaining component 212, selection component 214, configuration component 216 and/or waveform direction component 220).

The qubit control electronics management system 202 and/or a component thereof as described herein, can be communicatively, electrically, operatively, optically and/or otherwise coupled to one another via a bus 205. Bus 205 can comprise one or more of a memory bus, memory controller, peripheral bus, external bus, local bus, quantum bus and/or another type of bus that can employ one or more bus architectures. One or more of these examples of bus 205 can be employed.

In one or more embodiments, the qubit control electronics management system 202 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more embodiments, one or more of the components of the qubit control electronics management system 202 and/or of the non-limiting system 200 can reside in the cloud, and/or can reside locally in a local computing environment (e.g., at a specified location).

In general, the non-limiting system 200 can employ any suitable method of communication (e.g., electronic, communicative, internet, infrared, fiber, etc.) to provide communication between the qubit control electronics management system 202 and the quantum system 301.

In addition to the processor 206 and/or memory 204 described above, the qubit control electronics management system 202 can comprise one or more computer and/or machine readable, writable and/or executable components and/or instructions that, when executed by processor 206, can provide performance of one or more operations defined by such component and/or instruction.

Discussion next turns to the additional components of the qubit control electronics management system 202 (e.g., obtaining component 212, selection component 214, configuration component 216 and/or waveform direction component 220).

Turning first to the obtaining component 212, the obtaining component 212 can generally find, locate, determine, request, download, read and/or otherwise obtain a relative resonant frequency, e.g., a qubit resonant frequency of a qubit 307, or a readout resonant frequency of a readout resonator associated with the qubit 307, to thereby use the qubit resonant frequency to setup qubit control electronics 308 that are communicatively coupled to physical hardware of the qubit 307 for controlling the qubit 307 and/or a readout resonator associated therewith. That is, the setup of the qubit control electronics 308 can be at least partially based on the qubit resonant frequency or readout resonator resonant frequency obtained by the obtaining component 212. Information defining the qubit resonant frequency can be transmitted to and/or obtained by any other component of the qubit control electronics management system 202, such as the selection component 214 and/or the waveform direction component 220.

In one or more embodiments, the qubit resonant frequencies of one or more qubits of a quantum payload (e.g., of a quantum processor 306) of the quantum system 301 can be stored at a database in any suitable location and in any suitable format, such as a lookup table.

In one or more embodiments, a qubit control electronics 308 can control one qubit 307/readout resonator or more than one qubit 307/readout resonator. In one or more embodiments, a qubit 307/readout resonator can be communicatively coupled to one qubit control electronics 308 or more than one qubit control electronics 308.

The obtaining component 212 further can generally find, locate, determine, request, download, read and/or otherwise obtain a running frequency 388 of a digital to analog converter (DAC) clock 319 of a DAC 313 of the qubit control electronics 308 and/or an operating frequency (OF) 386 of a free running oscillator 309 of the qubit control electronics 308.

It is appreciated that description herein of and/or relating to a DAC 313 can apply to a control DAC (e.g., control DAC 313C) at a drive path of qubit electronics (e.g., qubit electronics 308) and/or to a readout DAC (e.g., readout DAC 313R) at an acquire path of the qubit electronics.

In one or more embodiments, the free running oscillator 309 can be a numerically controlled oscillator 309. Additionally and/or alternatively, the free running oscillator 309 can be built into the DAC 313 of the qubit control electronics 308.

Further, the DAC 313 can be free of (e.g., lacking) any time phase control of the oscillator 309. Instead, as indicated, the oscillator 309 can be continuously free running, whether or not the DAC 313 is generating an intermediate frequency (IF) 284 or outputting a resonating frequency (RF) 282.

In one or more embodiments, the obtaining component 212 further can generally find, locate, determine, request, download, read and/or otherwise obtain the OF 386 of an oscillator 309. In one or more embodiments, the oscillator 309 can be a free running oscillator 309 that is built into a DAC 313, such as a control DAC 313C and/or a readout DAC 313R.

Next, prior to discussion of use of the resonant frequency, OF 386 and/or running frequency 388 obtained by the obtaining component 212, and thus of one or more processes that can be performed by the selection component 214 and/or waveform direction component 220 relative to the qubit control electronics 308, discussion first turns to a general description of an exemplary quantum system 301 that can comprise the qubit control electronics 308.

Turning to FIG. 3, one or more embodiments described herein can include one or more devices, systems and/or apparatuses that can provide a process to generate one or more waveforms or pulses for a quantum-based operation (e.g., using a quantum device), such as for operating one or more qubits of a quantum device. Accordingly, at FIG. 3, illustrated is a block diagram of an example, non-limiting system 300 that can at least partially facilitate such a process. While referring here to one or more processes, facilitations and/or uses of the non-limiting system 300, description provided herein, both above and below, also can be relevant to one or more other non-limiting systems described herein, such as the non-limiting systems 100 and/or 200.

As illustrated at FIG. 3, the non-limiting system 300 can comprise a quantum system 301 that can be employed with or separate from the classical systems 102/202.

Generally, the quantum system 301 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 320, can be responsive to the quantum job request 324 and associated input data and can be based at least in part on the input data, quantum functions and/or quantum computations.

In one or more embodiments, the quantum system 301 can comprise components, such as a orchestrator component 303, a quantum processor 306, pulse component (e.g., a waveform generator 310) and/or a readout electronics 312 (e.g., readout component).

The quantum processor 306 can comprise one or more, such as plural, qubits 307. Individual qubits 307A, 307B and 307C, for example, can be fixed frequency and/or single junction qubits, such as transmon qubits.

In one or more embodiments, a readout resonator can be associated with, such as located with physical hardware defining a qubit 307.

In one or more embodiments, a memory 316 and/or processor 314 can be associated with the orchestrator component 303, where suitable. The processor 314 can be any suitable processor. The processor 314 can generate one or more instructions for controlling the one or more processes of the orchestrator component 303, such as for controlling one or more subordinate controllers (e.g., qubit control electronics 308).

The orchestrator component 303 can obtain (e.g., download, receive, search for and/or the like) a quantum job request 324 requesting execution of one or more quantum programs and/or a physical qubit layout. The quantum job request 324 can be provided in any suitable format, such as a text format, binary format and/or another suitable format. In one or more embodiments, the quantum job request 324 can be obtained by a component other than of the quantum system 301, such as a by a component of the classical systems 102/202.

The orchestrator component 303 can determine mapping of one or more quantum logic circuits for executing a quantum program. In one or more embodiments, the orchestrator component 303 and/or quantum processor 306 can direct the waveform generator 310 to generate one or more pulses, tones, waveforms and/or the like to affect one or more qubits 307, such as in response to a quantum job request 324.

In one or more embodiments, more than one orchestrator component 303 can be comprised by the quantum system 301.

The one or more orchestrator components 303 can be employed to control one or more qubit control electronics 308. Thus, the one or more qubit control electronics 308 can be communicatively coupled to the one or more orchestrator components 303.

Qubit control electronics 308 can be employed by the quantum processor 306 and disposed within a room temperature environment external to the cryogenic environment 317, as illustrated. In one or more embodiments, one or more aspects of one or more qubit control electronics can be disposed within a cryogenic environment 317.

In one or more embodiments a qubit control electronics 308 can be provided per qubit 307. In one or more embodiments, a qubit control electronics 308 can be provided to communicate with more than one qubit 307 per that qubit control electronics 308.

In one or more embodiments, a qubit control electronics 308 can be and/or can comprise a qubit drive card (e.g., a waveform generator 310) and/or a qubit acquire card (e.g., readout electronics 312).

In one or more embodiments, a qubit control electronics 308 can be and/or can comprise only one of a qubit drive card or a qubit acquire card. In one or more embodiments, a qubit control electronics 308 can comprise more than one qubit drive card and/or more than one qubit acquire card.

A waveform generator 310 can generally cause at least one qubit 307 of the quantum processor 306 to perform one or more quantum processes, calculations and/or measurements by creating a suitable electro-magnetic signal. For example, the waveform generator 310 can operate one or more qubit effectors, such as qubit oscillators, harmonic oscillators, pulse generators and/or the like to cause one or more pulses to stimulate and/or manipulate the state(s) of the one or more qubits 307 comprised by the quantum system 301. Indeed, a signal can be generated by the waveform generator 310 to affect one or more of the plurality of qubits 307.

In one or more embodiments, the waveform generator 310 can direct application of such electro-magnetic signal by use of the various qubit control electronics 308.

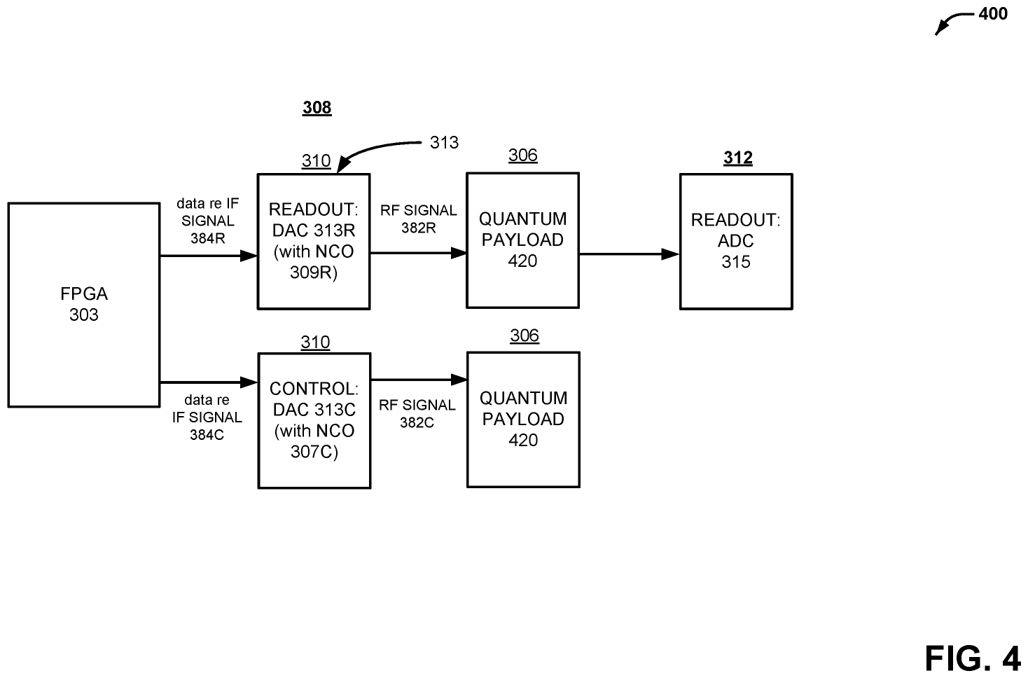

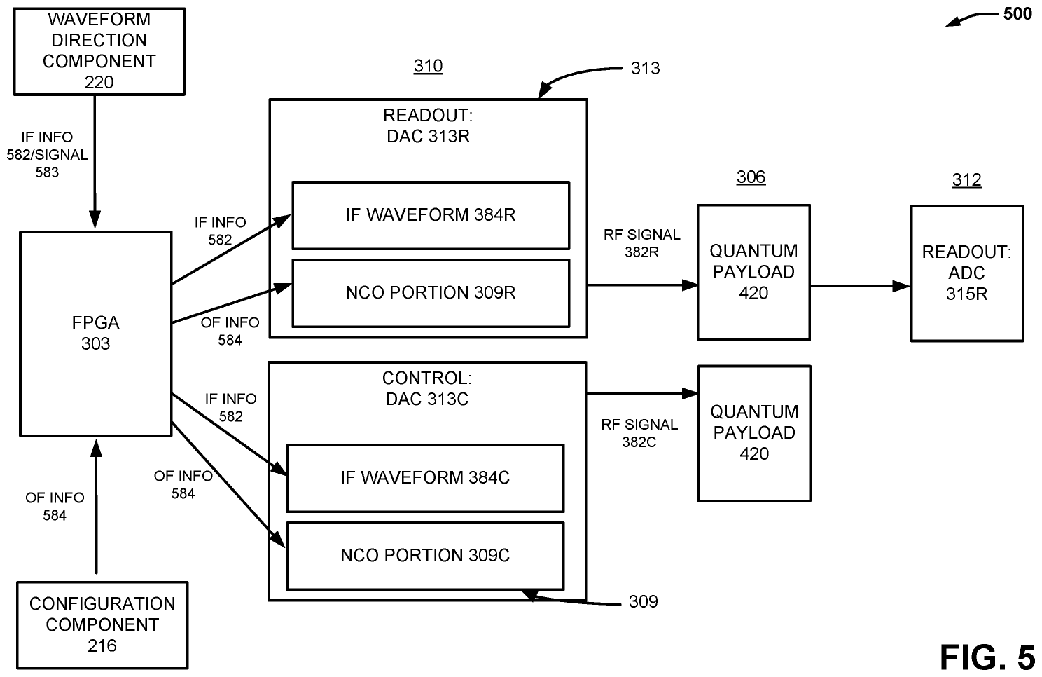

In one or more embodiments (see, e.g., FIG. 4), a qubit control electronics 308 can be and/or can comprise a digital to analog converter (DAC) 313 having a built-in oscillator 309 such as a numerically controlled oscillator (NCO) 309. For example, in one or more embodiments (see, e.g., FIG. 5) a qubit drive card (e.g., a waveform generator 310) can comprise a DAC 313 having a built-in oscillator 309 such as a numerically controlled oscillator (NCO) 309.

In one or more embodiments, a single DAC 313 can be employed for both a control path and a readout path of one or more qubits 307.

In one or more embodiments, qubit control electronics 308 can comprise a pair of DACs 313, such as a DAC 313R and a DAC 313C, where the DAC 313R can be employed at a readout path and the DAC 313C can be employed at a control path for control of one or more qubits 307.

In the one or more embodiments of a single DAC 313 or a pair of DACs 313C and 313R, any of these DACs 313 can comprise a built-in oscillator 309, such as a numerically controlled oscillator (NCO) 309. Briefly, this can allow for any one or more of direct generation and transmission of resonating frequencies (RFs) to qubits and/or to readout resonators associated with the qubits, reduced use of real estate in control electronics space of a quantum system, increased density, reduced cabling, and/or reduced card footprint used by individual qubit control electronics (as compared to existing frameworks), and/or reduction in and/or omission of separate oscillator components as a cost-saving mechanism.

The quantum processor 306 can be contained in a cryogenic environment, such as generated by a cryogenic environment 317, such as effected by a dilution refrigerator. Where the plurality of qubits 307 are superconducting qubits, cryogenic temperatures, such as about 4K or lower, can be employed for function of these physical qubits.

The readout electronics 312 can comprise and/or be comprised by the acquire card. The readout electronics 312 and/or the acquire card can comprise an analog to digital converter (ADC) 315 that can be employed for the readout path of one or more qubits 307. The readout electronics 312, or at least a portion thereof, can be contained in a room temperature environment or the cryogenic environment 317, such as for reading a state, frequency and/or other characteristic of qubit, excited, decaying or otherwise. Accordingly, one or more elements of the readout electronics 312 also can be constructed to perform at such cryogenic temperatures.

In one or more embodiments, more than one cryogenic environment, such as more than one dilution refrigerator, can be comprised by the quantum system 301.

It is noted that one or more aspects of the aforementioned description refers to the operation of a single set of instructions run relative a single qubit controller or set of qubit control electronics. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

Turning now back to FIG. 2 in addition to still referring to FIG. 3, discussion turns to one or more processes performed by the selection component 214 and waveform direction component 220.

Generally, the selection component 214 can identify a set of frequencies 270 for an operating frequency (OF) 386 (e.g., a known OF 386) of a free running oscillator 309 of qubit control electronics 308 corresponding to a qubit 307 of a quantum system 301.

In one or more embodiments, the set of frequencies 270 are multiples of a running frequency 388 of a digital to analog convertor (DAC) clock 319 of the qubit control electronics 308. In one or more embodiments, the selection component 214 can employ the running frequency 388 obtained by the obtaining component 212, upon which the OF 386 of the oscillator 309 can be based (e.g., where the OF 386 is a multiple of the running frequency 388).

Further, the set of frequencies 270 can be a subset of the full set of frequencies 270, which subset are within a target range of resonant frequencies of a plurality of qubits 307 (e.g., the qubits 307 or the readout resonators associated therewith), including the qubit 307 mentioned in the previous paragraph, of the quantum system 301.

Put another way, the setup component 214 can determine the set of frequencies 270 from which a single frequency thereof can be employed as the OF 386 (e.g., into which a running frequency 388 of the DAC clock 319 is divisible as a whole number). As will be described below, this can allow for maintaining of constant phase during launching of various IF signals 384 over various experiments.

For example, a DAC clock at the DAC 313 and/or at the field programable logic gate array (FPGA) 303 can run at an exemplary f0 running frequency 388. Accordingly, this number, as will be set forth below, describes the cycles of when the waveform direction component 220 can direct implementation of an IF signal 384 by the DAC, such as every 1/f0 seconds based on the particular exemplary f0 running frequency 388.

Separately, the oscillator (e.g., NCO 309) can be capable of producing operating frequencies that are a step size of a particular maximum frequency, such as a sampling frequency (fs), divided by a resolution of the NCO 309, such as 2^{(NCO bit resolution)}. That is, the maximum frequency dividing by the resolution can be the minimum frequency step size to which the NCO 309 can be set.

It is appreciated that the single frequency employed as the OF 386 can be determined by a user entity and/or by the selection component 214.

It is noted that input from a user entity can be made to any component, device, system and/or the like of the non-limiting system 200, such as to a device a communicatively coupled to the classical system 202 or to the quantum system 301.

Turning next briefly to the configuration component 216, the configuration component 216 generally can direct setting of the single selected operating frequency (OF) 386 of an oscillator 309 of the qubit control electronics 308, based on a selection by the selection component 214 from the set of one or more frequencies 270. It is noted that direction by the configuration component 216 can be directed/transmitted to any suitable component of the quantum system 301, such as the orchestrator component 303, directly to the qubit control electronics 308 comprising the oscillator 309 being set, etc. In one or more embodiments, the orchestrator component 303 can be instructed (e.g., by the configuration component 216), and the orchestrator component 303 can in turn direct the setting of the oscillator 309.

Turning next to the waveform direction component 220 in particular, based on the known OF 386, and on the running frequency 288, the waveform direction component 220 generally can maintain a constant phase relationship between varying resonating frequency (RF) pulses 382 output by the qubit control electronics 308, such as by the DAC 313. It is noted that discussion herein to a DAC 313 can apply equally to a control DAC 313C and/or to a readout DAC 313R as described herein.

As used herein, “phase” can refer to a relationship between two or more signals that share a same frequency. More particularly, phase can involve a relationship between positions of oscillatory aspects, such as amplitude crests and troughs of between waveforms defining the signals.

More particularly, the waveform direction component 220 can direct generation of the varying RF pulses 382 at intervals (e.g., of the NCO 309 OF 386) based on the running frequency 388 of the DAC clock 319, of the qubit control electronics 308. Put another way, the waveform direction component 220 can direct generation of the varying RF pulses 382 at boundaries of intervals of the OF 386, which boundaries are aligned to common cycle aspects of the OF 386.

This direction can be to the quantum system 301, such as to the DAC 313 by way of directing the FPGA 303 to direct the DAC 313, or directly to the DAC 313.

In one or more embodiments, the waveform direction component 220 can comprise a compiler portion that can generate and transmit, to the FPGA 303, an IF instruction set (e.g., IF info 582) for a quantum job request 324 (e.g., execution of a quantum circuit, calibration, etc.). The IF instruction set can comprise control and/or readout instructions to produce an control and/or readout IF waveform 384C and/or 384R, thereby resulting in generation, by the respective DAC 313C or 313R, of a respective control RF signal 382C and/or readout RF signal 382R.

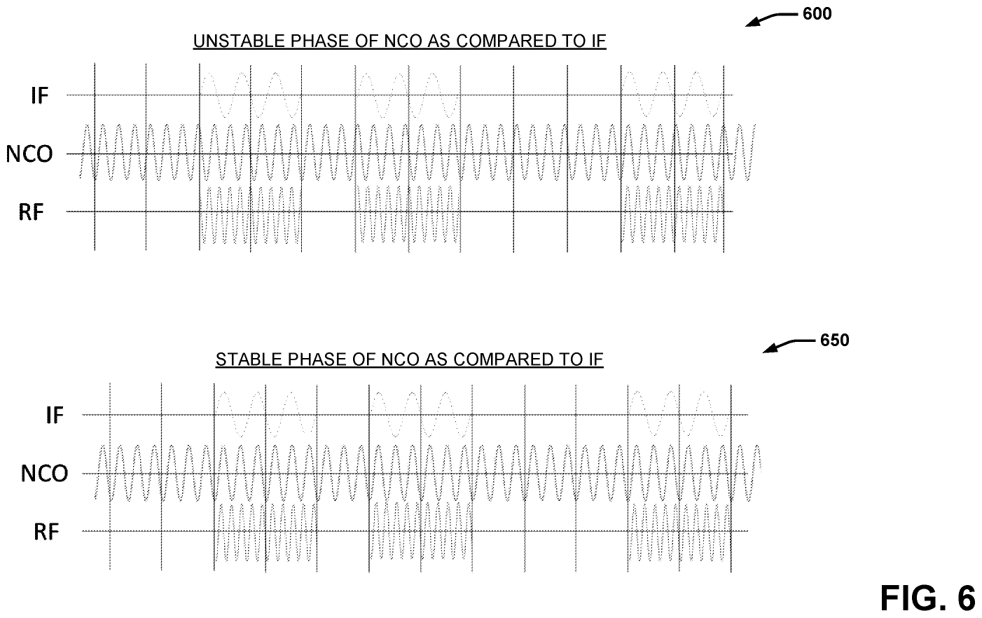

For example, turning briefly to FIG. 6, illustrated are a pair of graphs 600 and 650 illustrating relationships between intermediate frequency 284 pulses generated at different times relative to a free running operating frequency 286 of an NCO 309, and further illustrating resonating frequency 282 pulses generated as a result of combining of the IF 284 pulses with the free running OF 386.

As illustrated at graph 600, relative to an invalid OF 386 of an NCO 309, a set of three separately launched IF 284 pulses are generated by the DAC 313 and immediately combined with the invalid OF 386. Unfortunately, due to the free running nature of the NCO 309, and due to the invalid OF 386 of the NCO 309, each of the three identical IF 284 pulses interacts with a different phase of the OF 386, thereby, undesirably resulting in three completely different RF pulse 282 outputs.

Differently, as illustrated at graph 650, relative to a selectively determined OF 386 of an NCO 309, such as determined by a qubit control electronics management system 202 as set forth herein, a set of three separately launched IF 284 pulses are generated by the DAC 313 and immediately combined with the selectively determined OF 386. Regardless of the free running nature of the NCO 309, and rather due to the selectively determined OF 386 of the NCO 309, each of the three identical IF 284 pulses interacts with a same phase of the OF 386, thereby, as long as the IF 284 pulses are launched/combined at intervals of the OF 386 that correspond to the DAC clock of the DAC 313. Put another way, the IF 284 pulses are launched/combined when the OF 386 is operating at a multiple of the DAC clock, then the IF 284 pulses can be interacting with a same OF phase of the NCO 309 anytime the IF 284 pulses are launched along that set of intervals (e.g., at boundaries of intervals of the OF 386, which boundaries are aligned to common cycle aspects of the OF 386). Desirably, this results in three identical RF pulse 282 outputs.

At graph 650, due to the direction by the waveform direction component 220, each of the IF pulses 384 are generated at/aligned with common boundaries of intervals of the OF 386, which boundaries are aligned to common cycle aspects of the OF 386, as discussed above, to thereby maintain consistent alignment with the OF phase.

Turning now to FIGS. 4 and 5, but still referring to FIGS. 2 and 3, illustrated are processes that can be facilitated by the aforementioned operations performed by the classical system 202.

For example, in response to the direction by the waveform direction component 220, the DAC 313 generally can combine an intermediate frequency (IF) 284 with the OF 386 to generate an RF signal (or pulse) 382 having an RF 282, which RF 282 can be within the target range of the quantum payload 420 (FIG. 4), such as to GHz range to target a particular quantum frequency desired to be hit (e.g., a qubit resonant frequency of a qubit 307 of the quantum payload 420).

That is, first, more particularly, the orchestrator component 303, such as comprising a field programmable logic gate array (FPGA) or a separate FPGA 303 of the quantum system 301 can receive/obtain IF information 582 (e.g., comprising information for constructing an IF pulse 384 and/or information for timing of the IF pulse 384) from the waveform direction component 220, and can send a signal 583 (same or different signal 583) comprising the IF information 582 defining the IF 284 to the DAC 313. Alternatively and/or additionally, the IF information 582 can be sent directly to the DAC 313, such as by the waveform direction component 220.

That is, the DAC 313 is not always outputting a signal on the RF line. Rather, the output can be generated when an IF 284 is instructed/generated. By instructing timing of the generation of the IF 284/IF pulse 384 by the waveform direction component 220, the problem of the IF not necessarily being in lock step with the NCO 309 can be solved. That is, because phase on output of the DAC 313 is inherited by the NCO 309, a same phase of the NCO 309 can be employed for varying IF pulses 384.

As illustrated at FIG. 5, this process can be performed on the readout path or on the control path of the respective qubit control electronics 308. That is, the IF information 582 can be sent to the DAC 313R of the readout path (e.g., acquiring side) or to the DAC 313C of the control path (e.g., driving side).

Using the IF information 582, the DAC 313 can construct the IF 284 and combine the IF 284 with the OF 386. Based on the combining performed, the DAC 313 can generate an RF signal 382 having an RF 282 for targeting a qubit resonant frequency or readout resonator resonating frequency. Put another way, the DAC 313 is generating a MHz signal that is being combined by the DAC 313 with an OF 386 signal of the NCO 309 in GHz frequencies so that RF signal 384 output is in GHz range to target a particular quantum frequency desired to be hit.

In one or more embodiments, a set of one or more valid OF frequencies 270 can be generated by determining the set of OF frequencies that are divisible by the DAC clock. These frequencies each can be a phase stable frequency based on the DAC clock 313. In one or more embodiments, an exemplary subset of that set 270, for particularly targeting common quantum frequencies can be a subset of the valid OF frequencies. Referring to both the set 270 and the respective subset, the exemplary frequencies can allow for a timespan of the DAC clock period, resulting in a same point of identical IF pulses 384 frequency aligning at a DAC clock period. In one example, a frequency that is within the valid set can be chosen as a suitable NCO output frequency 386 at which to configure one or more NCOs 309 at one or more qubit control electronics 308 of the quantum system 301.

Nonetheless, apart from the description of the valid frequency numbers provided above, regardless of the particular OF 386, use of the qubit control electronics management system 202 can allow for maintaining a stable phase relationship between various output RF signals 382 and/or between the DAC 313 and the ADC 315.

Moreover, the aforementioned processes are still valid if the valid frequencies above are phase shifted, still allowing for the aforementioned constant phase relationship.

As a result, the RF signal 382 can be output to a qubit 307 controlled by the qubit control electronics 308, such as to the qubit 307 directly or to a readout resonator associated with the qubit 307.

For example, as illustrated at both FIGS. 4 and 5, the RF signal 382 generated can be a driving RF signal 382C that is output to the qubit 307 (e.g., to the physical hardware of the qubit 307), such as to affect a change of state of the qubit 307.

Alternatively, as also illustrated at both FIGS. 4 and 5, the RF signal 382 generated can be an acquiring RF signal 382R that is output to a readout resonator associated with the qubit 307 such as to affect measurement of the state of the qubit 307.

In this readout side example, the acquiring RF signal 382R can pass through the readout resonator to obtain information (at the RF signal 382R) about the qubit's state. A readout analog to digital converter (ADC) 315R can obtain the RF signal 382R that has passed through the quantum payload 420/qubit 307. In one or more embodiments, the ADC 315R can be comprised by and/or associated with the respective readout electronics 312 of the particular qubit control electronics 308. Based on the signal received by the ADC 315R, a quantum measurement readout 320 can be transmitted by the quantum system 301 to the classical system 202 and/or obtained by the classical system 202 from the quantum system 301.

Referring now generally to an aggregation of the processes identified above as being able to be performed by the qubit control electronics management system 202 and the DAC 313, such processes can be performed at least partially in parallel with one another for various other qubit control electronics 308 of the quantum system. Indeed, different qubits 307/readout resonators can have different resonant frequencies. Thus, separately or at least partially in parallel with one another, different OFs 386, IFs 384 and RFs 382 can be determined and/or generated relative to the different qubits 307/readout resonators of a same quantum system 301, such as using the same qubit control electronics management system 202 and the different respective DACs 313.

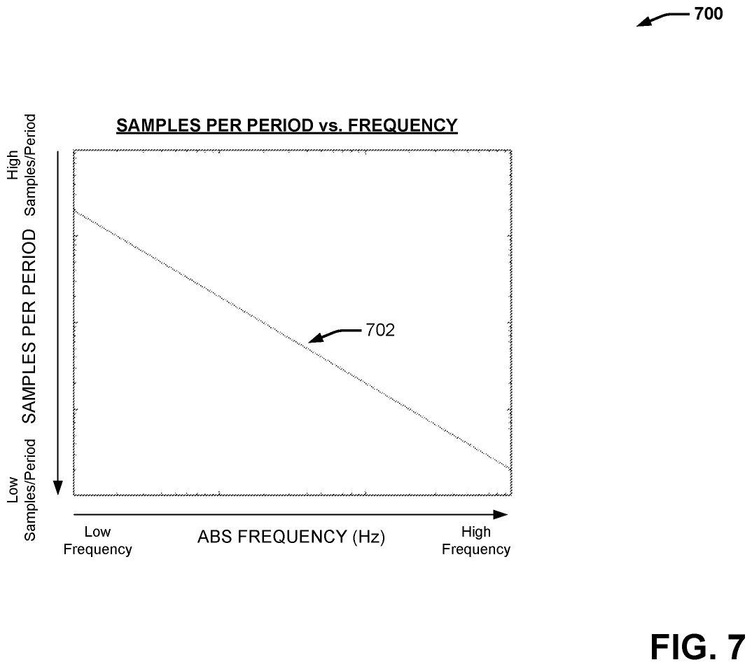

Turning now to FIG. 7, graph 700 illustrates effect of the Nyquist rate with samples per period on the y-axis and absolute value of frequencies (ABS) on the x-axis. The use of ABS can account for negative frequencies. The samples per period refers to the number of samples in a single period of a sinusoid oscillating at a given ABS frequency of the x-axis.

If observing the IF generally (e.g., prior to final generation by the DAC 313), as IF increases for a respective DAC 313, the amount of samples per period drop. Indeed, approaching high frequency, there are very few samples because the line 702 defining samples per period vs. frequency linearly drops off. Accordingly, selection of the set of frequencies 270, and of a single frequency of the set 270, by the selection component 214, can allow for maintaining distance from a respective Nyquist limit and limiting and/or preventing related Nyquist roll off.

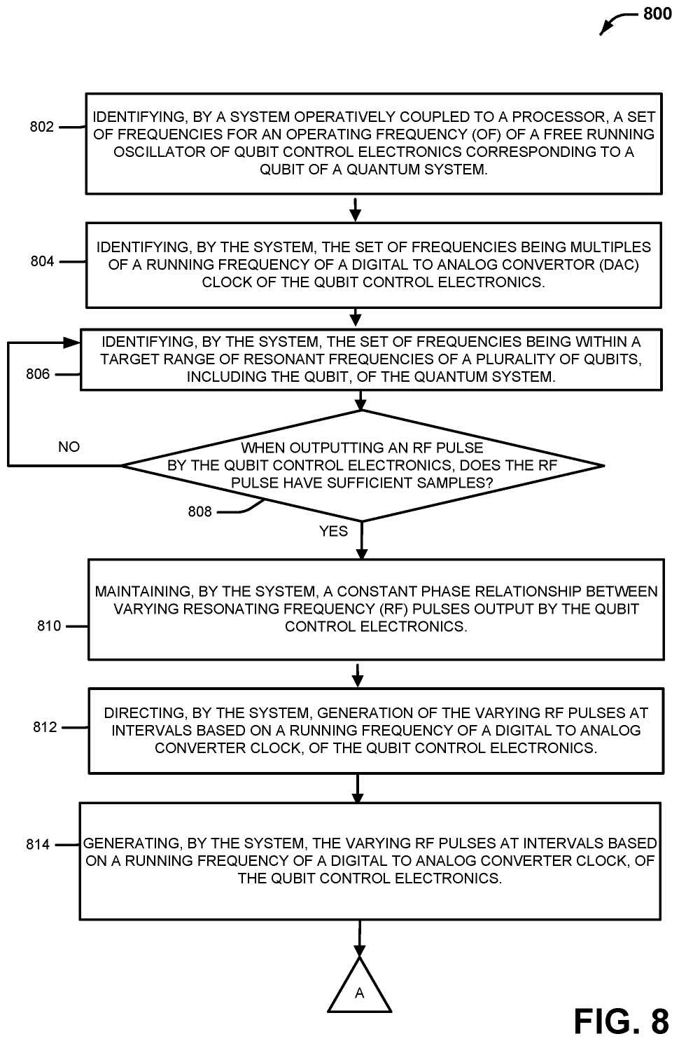

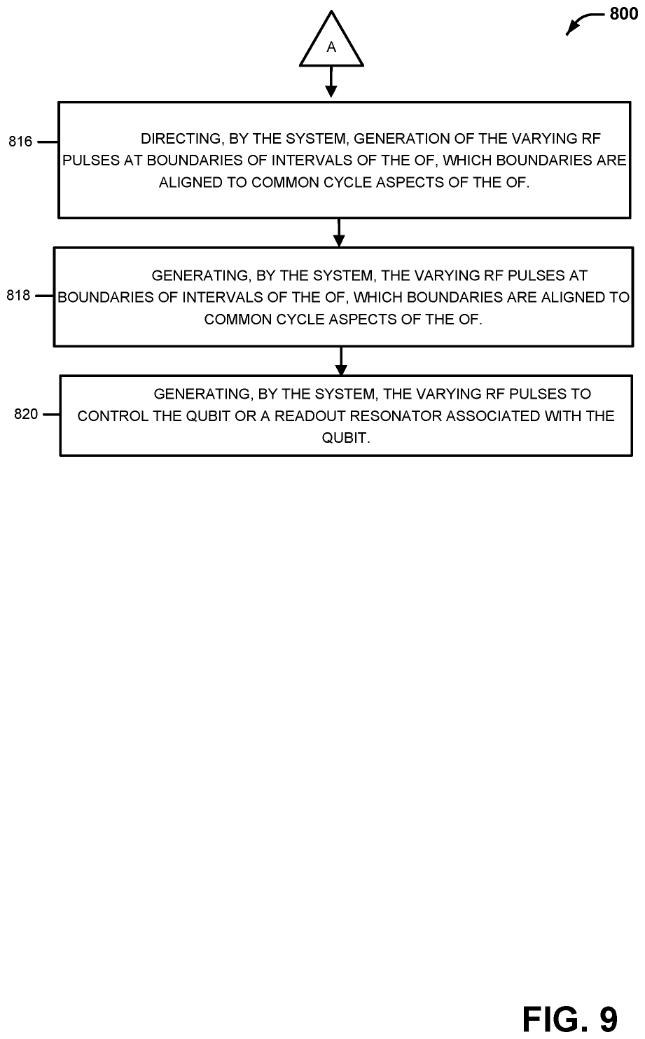

As a summary, referring next to FIGS. 8 and 9, illustrated is a flow diagram of an example, non-limiting method 800 that can provide a process to setup quantum system resources, such as qubit control electronics (e.g., qubit control electronics 308) of a quantum system (e.g., quantum system 301), in accordance with one or more embodiments described herein, such as the non-limiting system 200 of FIG. 2. While the non-limiting method 800 is described relative to the non-limiting system 200 of FIG. 2, the non-limiting method 800 can be applicable also to other systems described herein, such as the non-limiting system 100 of FIG. 1. Repetitive description of like elements and/or processes employed in respective embodiments is omitted for sake of brevity.

At 802, the non-limiting method 800 can comprise identifying, by a system operatively coupled to a processor (e.g., selection component 214), a set of frequencies (e.g., set of frequencies 270) for an operating frequency (OF) (e.g., OF 386) of a free running oscillator (e.g., FRNCO 309) of qubit control electronics (e.g., qubit control electronics 308) corresponding to a qubit (e.g., qubit 307) of a quantum system (e.g., quantum system 301).

In one or more embodiments, the oscillator is built into a digital to analog converter (e.g., DAC 313) of the qubit control electronics.

In one or more embodiments, the system (e.g., system 102, 202 and/or 100, 200) lacks time phase control of the oscillator.

At 804, the non-limiting method 800 can comprise identifying, by the system (e.g., selection component 214), the set of frequencies being multiples of a running frequency (e.g., running frequency 288) of a digital to analog convertor (DAC) clock (e.g., DAC clock 319) of the qubit control electronics.

At 806, the non-limiting method 800 can comprise identifying, by the system (e.g., selection component 214), the set of frequencies being within a target range of resonant frequencies of a plurality of qubits (e.g., qubits 307), including the qubit, of the quantum system.

At 808, the non-limiting method 800 can comprise determining, by the system (e.g., waveform direction component 220), whether, when outputting an RF pulse (e.g., RF signal 382) by the qubit control electronics, the RF pulse has sufficient samples. If yes, the non-limiting method 800 can proceed to step 810. If no, the non-limiting method can instead proceed back to step 806 to better determine a target range of resonant frequencies with the set of frequencies 270.

At 810, the non-limiting method 800 can comprise maintaining, by the system (e.g., waveform direction component 220), a constant phase relationship between varying resonating frequency (RF) pulses output by the qubit control electronics.

At 812, the non-limiting method 800 can comprise directing, by the system (e.g., waveform direction component 220) generation of the varying RF pulses at intervals based on a running frequency of a digital to analog converter clock, of the qubit control electronics.

At 814, the non-limiting method 800 can comprise generating, by the system (e.g., DAC 313 of the quantum system 301), the varying RF pulses at intervals based on a running frequency of a digital to analog converter clock, of the qubit control electronics.

At 816, the non-limiting method 800 can comprise directing, by the system (e.g., waveform direction component 220), generation of the varying RF pulses at boundaries of intervals of the OF (e.g., see, graph 650), which boundaries are aligned to common cycle aspects of the OF.

At 818, the non-limiting method can comprise generating, by the system (e.g., DAC 313 of the quantum system 301), the varying RF pulses at boundaries of intervals of the OF, which boundaries are aligned to common cycle aspects of the OF.

At 820, the non-limiting method 800 can comprise generating, by the system (e.g., DAC 313 of the quantum system 301), the varying RF pulses to control the qubit or a readout resonator associated with the qubit.

### Additional Summary

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, the one or more embodiments described herein can provide a system, computer-implemented method and/or computer program product to provide for control of a quantum system 301 through use of one or more digital to analog converters comprising built-in oscillators. A system 100, 200 comprises a memory 104, 204 that stores and a processor 106, 206 that executes computer executable components stored in the memory 104, 204, wherein the computer executable components comprise a selection component 114, 214 that identifies a set of frequencies 170, 270 for an operating frequency (OF) 386 of a free running oscillator 309 of qubit control electronics 308 corresponding to a qubit 307 of a quantum system 301, and a waveform direction component 120, 220 that maintains a constant phase relationship between varying resonating frequency (RF) pulses 382 output by the qubit control electronics 308.

A benefit of the system, computer-implemented method and/or computer program product can be an ability to, during quantum system setup, configure qubit control electronics that can, during use of the quantum system, directly generate and transmit resonating frequencies (RFs) to qubits and/or to readout resonators associated with the qubits to thereby drive the qubits and/or obtain readout measurements regarding the qubits' states, rotations, etc. function with qubits having varying resonant frequencies, including atypical frequencies. Indeed, quantum experiments can comprise a statistical process employing repeated trials. Maintaining stable phase amongst trials can allow for repeatable results.

Another benefit of the system, computer-implemented method and/or computer program product can be an ability to omit separate local oscillator components (e.g., those that are not built into digital to analog converters (DACs) thereby providing for reduced use of real estate in control electronics space of a quantum system. Accordingly, increased density, reduced cabling, and reduced card footprint used by individual qubit control electronics can be enabled, as compared to existing frameworks. The reduction in and/or omission of separate oscillator components further is a cost-saving mechanism.

Indeed, in view of the one or more embodiments described herein, a practical application of the one or more systems, computer-implemented methods and/or computer program products described herein can be an ability to control an increasingly large quantum payload using free running NCOs while still be able to maintain consistent phase between varying RF pulses generated by the qubit control electronics of a quantum system, comprising the quantum payload, and between a DAC and an ADC of the qubit control electronics.

In connection therewith, the one or more embodiments described herein can provide useful and practical applications of computers, thus providing enhanced (e.g., improved and/or optimized) quantum system setup as compared to existing frameworks. Overall, such computerized tools can constitute a concrete and tangible technical improvement in the field of quantum processing.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to quantum payload control and/or control setup, as compared to existing systems and/or techniques unable to provide quantum payload control and/or control setup. Systems, computer-implemented methods and/or computer program products providing performance of these processes are of great utility in the fields of quantum computing and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively automatically or even partially automatically perform quantum control electronics setup as the one or more embodiments described herein can provide these processes. Moreover, neither can the human mind nor a human with pen and paper conduct one or more of these processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

To provide additional summary, a listing of embodiments and features thereof is provided.

A system, comprising: a memory that stores computer executable components; and a processor that executes the computer executable components stored in the memory, wherein the computer executable components comprise: a selection component that identifies a set of frequencies for an operating frequency (OF) of a free running oscillator of qubit control electronics corresponding to a qubit of a quantum system; and a waveform direction component that maintains a constant phase relationship between varying resonating frequency (RF) pulses output by the qubit control electronics.

The system of the preceding paragraph, wherein the set of frequencies are multiples of a running frequency of a digital to analog convertor (DAC) clock of the qubit control electronics.

The system of any preceding paragraph, wherein the set of frequencies are within a target range of resonant frequencies of a plurality of qubits, including the qubit, of the quantum system.

The system of any preceding paragraph, wherein the waveform direction component directs generation of the varying RF pulses at intervals based on a running frequency of a digital to analog converter clock, of the qubit control electronics.

The system of any preceding paragraph, wherein the waveform direction component directs generation of the varying RF pulses at boundaries of intervals of the OF, which boundaries are aligned to common cycle aspects of the OF.

The system of any preceding paragraph, wherein the oscillator is built into a digital to analog converter of the qubit control electronics.

The system of any preceding paragraph, wherein the system lacks time phase control of the oscillator.

The system of any preceding paragraph, further comprising: a digital to analog converter (DAC), of the qubit control electronics, that generates the varying RF pulses to control the qubit or a readout resonator associated with the qubit.

A computer-implemented method, comprising: identifying, by a system operatively coupled to a processor, a set of frequencies for an operating frequency (OF) of a free running oscillator of qubit control electronics corresponding to a qubit of a quantum system; and maintaining, by the system, a constant phase relationship between varying resonating frequency (RF) pulses output by the qubit control electronics.

The computer-implemented method of the preceding paragraph, wherein the set of frequencies are multiples of a running frequency of a digital to analog convertor (DAC) clock of the qubit control electronics.

The computer-implemented method of any preceding paragraph, wherein the set of frequencies are within a target range of resonant frequencies of a plurality of qubits, including the qubit, of the quantum system.

The computer-implemented method of any preceding paragraph, further comprising: generating, by the system, the varying RF pulses at intervals based on a running frequency of a digital to analog converter clock, of the qubit control electronics.

The computer-implemented method of any preceding paragraph, further comprising: generating, by the system, the varying RF pulses at boundaries of intervals of the OF, which boundaries are aligned to common cycle aspects of the OF.

The computer-implemented method of any preceding paragraph, wherein the oscillator is built into a digital to analog converter of the qubit control electronics.

The computer-implemented method of any preceding paragraph, wherein the system lacks time phase control of the oscillator.

The computer-implemented method of any preceding paragraph, further comprising: generating, by the system, the varying RF pulses to control the qubit or a readout resonator associated with the qubit.

A computer program product facilitating a process to support control of output of resonating frequencies of qubit control electronics of a quantum system, the computer program product comprising a computer readable storage medium having program instructions embodied therewith, the program instructions executable by a processor to cause the processor to: identify, by the processor, a set of frequencies for an operating frequency (OF) of a free running oscillator of the qubit control electronics corresponding to a qubit of the quantum system; and maintain, by the processor, a constant phase relationship between varying resonating frequency (RF) pulses output by the qubit control electronics.

The computer program product of the preceding paragraph, wherein the set of frequencies are multiples of a running frequency of a digital to analog convertor (DAC) clock of the qubit control electronics, and wherein the set of frequencies are within a target range of resonant frequencies of a plurality of qubits, including the qubit, of the quantum system.

The computer program product of any preceding paragraph, wherein the program instructions are further executable by the processor to cause the processor to: generate, by the processor, the varying RF pulses at intervals based on a running frequency of a digital to analog converter clock, of the qubit control electronics.

The computer program product of any preceding paragraph, wherein the program instructions are further executable by the processor to cause the processor to: generate, by the processor, the varying RF pulses at boundaries of intervals of the OF, which boundaries are aligned to common cycle aspects of the OF.

### Computing Environment Description

Turning next to FIG. 10, a detailed description is provided of additional context for the one or more embodiments described herein at FIGS. 1-9.

FIG. 10 and the following discussion are intended to provide a brief, general description of a suitable computing environment 1000 in which one or more embodiments described herein at FIGS. 1-9 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as translation of an original source code based on a configuration of a target system by the DAC setup and/or use code 1080. In addition to block 1080, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1080, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1080 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid-state storage devices. Operating system 1022 may take several forms, such as various known proprietary operating systems or open-source Portable Operating System Interface type operating systems that employ a kernel. The code included in block 1080 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001) and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine that collects and stores helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

### ADDITIONAL CLOSING INFORMATION

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a selection component that identifies a set of frequencies for an operating frequency (OF) of a free running oscillator of qubit control electronics corresponding to a qubit of a quantum system; and
a waveform direction component that maintains a constant phase relationship between varying resonating frequency (RF) pulses output by the qubit control electronics.

2. The system of claim 1, wherein the set of frequencies are multiples of a running frequency of a digital to analog convertor (DAC) clock of the qubit control electronics.

3. The system of claim 1, wherein the set of frequencies are within a target range of resonant frequencies of a plurality of qubits, including the qubit, of the quantum system.

4. The system of claim 1, wherein the waveform direction component directs generation of the varying RF pulses at intervals based on a running frequency of a digital to analog converter clock, of the qubit control electronics.

5. The system of claim 1, wherein the waveform direction component directs generation of the varying RF pulses at boundaries of intervals of the OF, which boundaries are aligned to common cycle aspects of the OF.

6. The system of claim 1, wherein the oscillator is built into a digital to analog converter of the qubit control electronics.

7. The system of claim 1, wherein the system lacks time phase control of the oscillator.

8. The system of claim 1, further comprising:
a digital to analog converter (DAC), of the qubit control electronics, that generates the varying RF pulses to control the qubit or a readout resonator associated with the qubit.

9. A computer-implemented method, comprising:
identifying, by a system operatively coupled to a processor, a set of frequencies for an operating frequency (OF) of a free running oscillator of qubit control electronics corresponding to a qubit of a quantum system; and
maintaining, by the system, a constant phase relationship between varying resonating frequency (RF) pulses output by the qubit control electronics.

10. The computer-implemented method of claim 9, wherein the set of frequencies are multiples of a running frequency of a digital to analog convertor (DAC) clock of the qubit control electronics.

11. The computer-implemented method of claim 9, wherein the set of frequencies are within a target range of resonant frequencies of a plurality of qubits, including the qubit, of the quantum system.

12. The computer-implemented method of claim 9, further comprising:
generating, by the system, the varying RF pulses at intervals based on a running frequency of a digital to analog converter clock, of the qubit control electronics.

13. The computer-implemented method of claim 9, further comprising:
generating, by the system, the varying RF pulses at boundaries of intervals of the OF, which boundaries are aligned to common cycle aspects of the OF.

14. The computer-implemented method of claim 9, wherein the oscillator is built into a digital to analog converter of the qubit control electronics.

15. The computer-implemented method of claim 9, wherein the system lacks time phase control of the oscillator.

16. The computer-implemented method of claim 9, further comprising: generating, by the system, the varying RF pulses to control the qubit or a readout resonator associated with the qubit.

17. A computer program product facilitating a process to support control of output of resonating frequencies of qubit control electronics of a quantum system, the computer program product comprising a computer readable storage medium having program instructions embodied therewith, the program instructions executable by a processor to cause the processor to:
identify, by the processor, a set of frequencies for an operating frequency (OF) of a free running oscillator of the qubit control electronics corresponding to a qubit of the quantum system; and
maintain, by the processor, a constant phase relationship between varying resonating frequency (RF) pulses output by the qubit control electronics.

18. The computer program product of claim 17, wherein the set of frequencies are multiples of a running frequency of a digital to analog convertor (DAC) clock of the qubit control electronics, and wherein the set of frequencies are within a target range of resonant frequencies of a plurality of qubits, including the qubit, of the quantum system.

19. The computer program product of claim 17, wherein the program instructions are further executable by the processor to cause the processor to:
generate, by the processor, the varying RF pulses at intervals based on a running frequency of a digital to analog converter clock, of the qubit control electronics.

20. The computer program product of claim 17, wherein the program instructions are further executable by the processor to cause the processor to:
generate, by the processor, the varying RF pulses at boundaries of intervals of the OF, which boundaries are aligned to common cycle aspects of the OF.
